(19) United States
(12) Patent Application Publication
(10) Pub. No.: US 2024/0402290 A1
(43) Pub. Date: Dec. 5, 2024

(54) RADAR APPARATUSES AND METHODS

(71) Applicant: Infineon Technologies AG, Neubiberg (DE)

(72) Inventor: Bernd-Ulrich KLEPSER, Starnberg (DE)

(21) Appl. No.: 18/676,021

(22) Filed: May 28, 2024

(30) Foreign Application Priority Data
Jun. 2, 2023 (DE) 102023114506.1

(51) Int. Cl. G01S 7/35; G01S 7/40; G01S 13/32

(52) U.S. Cl. CPC G01S 7/352; G01S 7/4013; G01S 7/4021; G01S 13/32

(57) ABSTRACT

The present disclosure relates to a radar apparatus. The radar apparatus includes a transceiver circuit with a frequency synthesizer. The radar apparatus further includes a control circuit configured to set different operational modes of the transceiver circuit. The control circuit is configured to control the transceiver circuit to, in a detection mode, emit a sequence of subsequent FMCW radar chirps in a transmit frequency band between a minimum frequency and a maximum frequency, and, in another operational mode different from the detection mode, perform one or more other operations of the transceiver circuit by adjusting the frequency synthesizer to a frequency outside the transmit frequency band.

### CROSS-REFERENCE TO RELATED APPLICATION

This application claims priority to German Patent Application No. 102023114506.1 filed on Jun. 2, 2023, the content of which is incorporated by reference herein in its entirety.

### TECHNICAL FIELD

The present disclosure generally relates to radar systems, and, more particularly, to radar apparatuses and methods for improving a spectral occupation of radar systems.

### BACKGROUND

Radar is an acronym for Radio Detection and Ranging. Radar systems use radio waves to detect and locate objects at a distance. The radar system sends out a radio signal, which is reflected by an object and received by the radar system. A time delay between the transmission and reception of the signal may be used to determine the distance to the object, while the Doppler shift of the reflected signal may be used to determine the object's velocity.

Radar systems may be used in a wide range of applications, including autonomous driving, air traffic control, weather monitoring, surveillance, and military applications. Basic components of a radar system include a transmitter, a receiver, one or more antennas, and a signal processor. The transmitter sends out a radio signal, which is reflected by the object and received by an antenna. The receiver amplifies and processes the reflected signal, which is then analyzed by the signal processor to determine the distance, velocity, and other characteristics of the object.

International regulations of spectral occupation of radar systems are based on limits for emission of spectral densities for radar signals (wanted emissions), calibration signals (auxiliary signals) and spurious (unwanted emissions). Chirp-based sequences of FMCW (Frequency Modulated Continuous Wave) radar signals with a frequency ramp as the wanted signal, and mostly constant frequencies during Phase Locked Loop (PLL) settling between ramps and during calibrations may result in a non-uniform and suboptimum usage of the frequency spectrum.

In addition to the wanted signal of the radar chirp plus the auxiliary signals, the use of highly digital Radio Frequency (RF) architectures like all-digital PLLs may lead to a set of unwanted signals at well-defined frequency offsets to the chirp frequencies. These digital architectures leverage the digital speed and signal processing power of sub-micron technologies and are mostly used to replace highly accurate analog circuitry that would not shrink significantly with technology node. The frequency offsets are thereby determined by the applied digital clock frequencies and the power spectral density is determined by the amount of digital activity.

The regulations further limit the spectral power densities of unwanted emissions dependent on their frequency offset from the center frequency of the radar sequence. In some cases the spectral power density of this unwanted signal may limit the output power of the radar chirps.

Thus, there may be a demand to improve the spectral occupation for radar signals and/or calibration signals.

### SUMMARY

This demand is met by methods and apparatuses in accordance with the appended claims.

According to a first aspect, the present disclosure proposes a radar apparatus. The radar apparatus includes a transceiver circuit. The transceiver circuit includes (among other components) a frequency synthesizer. The radar apparatus further includes a control circuit configured to set different operational modes of the transceiver circuit. In a detection mode, the transceiver circuit can be controlled to emit at least one sequence (or a frame) of subsequent FMCW radar chirps in a transmit frequency band between a minimum frequency and a maximum frequency. In another operational mode different from the detection mode, the transceiver circuit can be controlled to perform one or more other operations of the transceiver circuit by adjusting the frequency synthesizer to a frequency outside the transmit frequency band. That is, during the detection (and ranging) mode of the radar transceiver circuit, an occupied frequency spectrum of wanted emissions is between the minimum and the maximum frequency. During the other operational mode of the radar transceiver circuit, the occupied frequency spectrum is outside the transmit frequency band, for example, below or above the transmit frequency band. In this way, spectral spikes in the transmit frequency band may be reduced, for example. By reducing a height of the spikes, the maximum allowed emitted power density during the radar chirps may be increased, thus allowing a larger range of operation. By widening the spectral density of the radar sequence, the requirements of OOB (Out of Band) emissions can be relaxed to higher frequency offsets relative to a center frequency of the radar cycle.

In some implementations, the control circuit is configured to adjust the frequency synthesizer to one or more first frequencies inside the transmit frequency band during the detection mode and to adjust the frequency synthesizer to one or more second frequencies outside the transmit frequency band during the other operational mode. The skilled person having benefit from the present disclosure will appreciate that the first frequencies and/or the second frequencies may vary. For example, the first frequency and/or the second frequency may vary according to a respective frequency modulation scheme.

In some implementations, the control circuit is configured to set the detection mode of the transceiver circuit during a detection time interval corresponding to the sequence (or frame) of subsequent FMCW radar chirps and to set the other operational mode of the transceiver circuit during another time interval outside the detection time interval. The detection time interval may correspond to the time it takes to transmit the sequence (or frame) of subsequent FMCW radar chirps. The other time interval may be a time interval between two subsequent detection time intervals, for example. The detection time interval and the other time interval may be arranged according to a Time Division Multiplex (TDM) scheme.

In some implementations, the control circuit is configured to adjust, in the other operational mode, the frequency synthesizer to a frequency which is equal to or smaller than 99.99% of the minimum frequency or which is equal to or larger than 100.01% of the maximum frequency of the transmit frequency band. For example, if the minimum frequency of the transmit frequency band was 24 GHz, the control circuit would be configured to adjust, in the other operational mode, the frequency synthesizer to a frequency which is at most 2.4 MHz below 24 GHz. Or if the maximum frequency of the transmit frequency band was 86 GHz, the control circuit would be configured to adjust, in the other operational mode, the frequency synthesizer to a frequency which is at least 8.6 MHz above 86 GHZ.

In some implementations, the control circuit is configured to vary, in the other operational mode, the frequency of the frequency synthesizer outside the transmit frequency band. This means that the frequency of the frequency synthesizer outside the transmit frequency band may also vary according to a frequency modulation scheme, for example.

In some implementations, the control circuit is configured to vary the frequency of the frequency synthesizer according to a linear frequency ramp or step function. Thus, a frequency modulation scheme in the other operational mode may also correspond to FMCW.

In some implementations, a variation bandwidth of the frequency of the frequency synthesizer outside the transmit frequency band is smaller than the transmit frequency band. In other words, the frequency variation bandwidth of the frequency synthesizer may be smaller outside the transmit frequency band than inside the transmit frequency band. Inside the transmit frequency band or within the detection mode, the frequency of the frequency synthesizer may be swept over a first range of frequencies. Outside the transmit frequency band or within the other operational mode, the frequency of the frequency synthesizer may be swept over a second range of frequencies. The second range of frequencies may be smaller than the first range of frequencies.

In some implementations, the other operational mode is a calibration or monitoring mode of the transceiver circuit prior or subsequent to the detection mode. The control circuit may be configured to adjust the frequency synthesizer to the frequency outside the transmit frequency band during the calibration or monitoring mode. In some implementations, the calibration or monitoring mode includes a transmitter and/or a receiver calibration/monitoring mode of the transceiver circuit. Examples for transmitter calibrations for FMCW radar are output power calibration, frequency sweep calibration, phase noise calibration, timing calibration, or antenna calibration. Examples for receiver calibrations for FMCW radar are gain calibration, phase calibration, frequency response calibration, timing calibration, or noise figure calibration.

In some implementations, the transmitter calibration mode is a power calibration mode or a phase calibration mode of the transceiver circuit. The control circuit may be configured to adjust the frequency synthesizer to a first frequency outside the transmit frequency band during the power calibration mode. The control circuit may be configured to adjust the frequency synthesizer to a second frequency outside the transmit frequency band during the phase calibration mode. The first and the second frequencies may be different frequencies. In this way, widening of the spectral density may be achieved.

In some implementations, the control circuit is further configured to, in the detection mode, vary a target frequency of the frequency synthesizer outside the transmit frequency band during a settling time interval of a PLL (of the frequency synthesizer) between the end of a first chirp and the start of a (directly) subsequent second chirp. During an FMCW radar chirp, an occupied frequency spectrum of wanted emissions is between the minimum and the maximum frequency. During the settling time interval of the PLL between subsequent FMCW radar chirps, the occupied frequency spectrum is outside transmit frequency band, for example, below or above the transmit frequency band. In this way, spectral spikes in the transmit frequency band may be reduced, for example. By reducing a height of the spikes the maximum allowed emitted power density during the radar chirps may be increased, thus allowing a larger range of operation. By widening the spectral density of the radar sequence, the requirements of OOB (Out of Band) emissions can be relaxed to higher frequency offsets relative to the center frequency of the radar cycle.

In some implementations, the control circuit is configured to adjust, in the other operational mode, the frequency synthesizer to a frequency between a spurious emission spectrum and the transmit frequency band. Here, spurious emission refers to an emission on a frequency, or frequencies, which are outside the transmit frequency band and the level of which may be reduced without affecting the corresponding transmission of information. Spurious emissions include harmonic emissions, parasitic emissions, intermodulation products and frequency conversion products but exclude out-of-band emissions. Out-of-band emission refers to an emission on a frequency or frequencies immediately outside the transmit frequency band which results from a modulation process, but excluding spurious emissions. This is, the out-of-band (OOB) emission spectrum is between the spurious emission spectrum and the transmit frequency band.

Thus, the control circuit may be configured to adjust, in the other operational mode, the frequency synthesizer to a frequency in a frequency spectrum between spurious intermodulation products and the transmit frequency band.

According to a second aspect, the present disclosure proposes a radar method. The radar method includes setting different operational modes of a radar transceiver circuit. In a detection mode, the transceiver circuit can be controlled emit at least one sequence (or a frame) of subsequent FMCW radar chirps in a transmit frequency band between a minimum frequency and a maximum frequency. In another operational mode different from the detection mode, the transceiver circuit can be controlled perform one or more other operations of the transceiver circuit by adjusting the frequency synthesizer to a frequency outside the transmit frequency band.

According to a further aspect, the present disclosure proposes a radar apparatus. The radar apparatus includes a transceiver circuit having a phase-locked loop (PLL) with a frequency synthesizer. The radar apparatus also includes a control circuit configured to cause the transceiver circuit to emit a sequence of subsequent FMCW radar chirps in a transmit frequency band between a minimum frequency and a maximum frequency. The control circuit is configured to vary a target frequency of the frequency synthesizer outside the transmit frequency band during a settling time interval of the PLL between the end of a first chirp and the start of a subsequent second chirp.

In some implementations, the sequence of subsequent FMCW radar chirps may have N chirps. The first chirp may be an n-th chirp of the sequence while the second chirp may be the (n+1)-th chirp of the sequence. Thus, the second chirp may be directly subsequent to the first chirp.

In some implementations, the control circuit is configured to vary the target frequency of the frequency synthesizer within a variation bandwidth, wherein the variation bandwidth is smaller than the transmit frequency band. For example,

According to yet a further aspect, the present disclosure proposes a radar method. The radar method includes causing a radar transceiver circuit to emit a sequence of subsequent FMCW radar chirps in a transmit frequency band between a minimum frequency and a maximum frequency, and varying a target frequency of a frequency synthesizer (of the radar transceiver circuit) outside the transmit frequency band during a settling time interval of a PLL (of the radar transceiver circuit) between the end of a first chirp and the start of a subsequent second chirp. That is, during an FMCW radar chirp, an occupied frequency spectrum of wanted emissions is between the minimum and the maximum frequency. During the settling time interval of the PLL between subsequent FMCW radar chirps, the occupied frequency spectrum is outside transmit frequency band, for example, below or above the transmit frequency band. In this way, spectral spikes in the transmit frequency band may be reduced, for example. By reducing a height of the spikes the maximum allowed emitted power density during the radar chirps may be increased, thus allowing a larger range of operation. By widening the spectral density of the radar sequence, the requirements of OOB (Out of Band) emissions can be relaxed to higher frequency offsets relative to the center frequency of the radar cycle.

### BRIEF DESCRIPTION OF THE DRAWINGS

Some examples of apparatuses and/or methods will be described in the following by way of example only, and with reference to the accompanying figures, in which

FIG. 1 shows a block diagram of a radar apparatus, in accordance with the present disclosure;

FIG. 2 shows an example of subsequent detection and calibration modes of the radar apparatus of FIG. 1;

FIG. 3 shows a spectral density of a conventional FMCW based radar sequence;

FIG. 4A shows a first example of subsequent detection and calibration modes, in accordance with the present disclosure;

FIG. 4B shows a second example of subsequent detection and calibration modes, in accordance with the present disclosure;

FIG. 4C shows an example of varying a target frequency of a frequency synthesizer outside a transmit frequency band during a settling time interval of a PLL, in accordance with the present disclosure;

FIG. 5 shows a spectral density of a FMCW based radar sequence, in accordance with the present disclosure;

FIG. 6 shows a flowchart of a first radar method, in accordance with the present disclosure; and

FIG. 7 shows a flowchart of a second radar method, in accordance with the present disclosure.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single clement is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

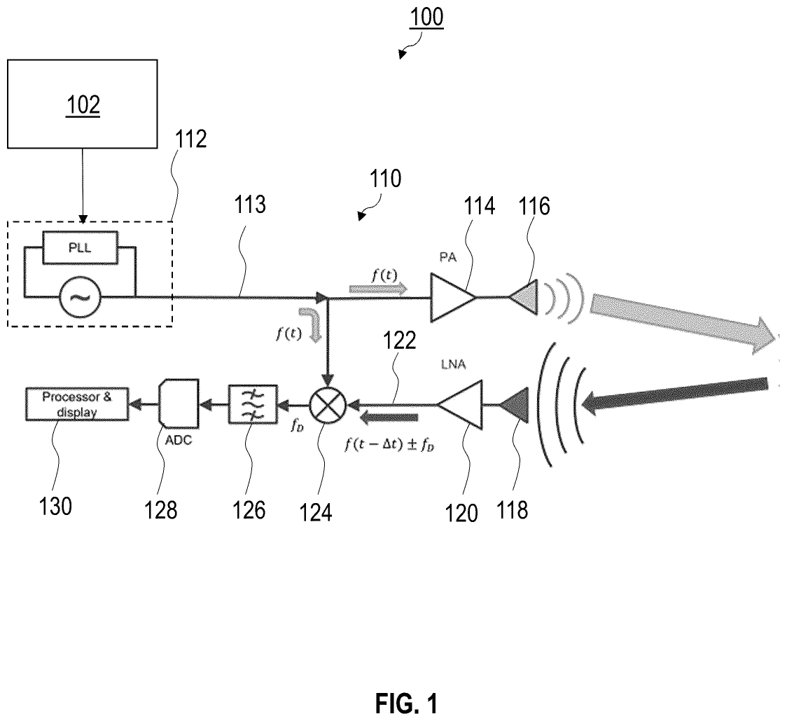

FIG. 1 shows a block diagram of a FMCW radar apparatus 100. FMCW radar apparatus 100 and its components may be implemented at least in part as Monolithic Microwave Integrated Circuit (MMIC), for example.

Radar apparatus 100 comprises a radar transceiver circuit 110. Radar transceiver (short for “transmitter-receiver”) circuit 110 is configured to emit radio waves and receive their reflections from objects in its vicinity. Radar transceiver circuit 110 comprises a transmitter portion, a receiver portion, and a frequency synthesizer 112 which may be used by both circuit portions. The frequency synthesizer 112 is an electronic circuit that generates and controls the radio frequency f(t) of a transmitted radar signal 113. The frequency synthesizer 112 may be implemented using a phase-locked loop (PLL) or a direct digital synthesizer (DDS) and may include components such as voltage-controlled oscillators (VCOs) and frequency dividers to generate and control a frequency of a transmitted radar signal 113. The frequency synthesizer 112 may produce a stable and precisely frequency modulated radar signal 113. The frequency modulated radar signal 113 may be amplified by power amplifier 114 and then transmitted from transmit antenna 116 towards one or more objects. The transmitted frequency modulated radar signal 113 may comprise a sequence of subsequent FMCW radar chirps (also referred to as pulses or ramps).

After reflecting off of the objects, captured by one or more receive antennas 118, and amplified by low-noise amplifier (LNA) 120, a receive signal 122 may be mixed with the transmitted FMCW chirp signal 113 at mixer 124 to produce a beat frequency. This beat frequency is proportional to the range of the target(s) and may be used to calculate the distance/range to the target(s). The beat frequencies resulting from mixing subsequent FMCW radar chirps of the transmitted signal 113 and the receive signal 122 may also be indicative of a Doppler shift due to relative velocities of the one or more objects. An output of mixer 124 may be filtered at 126 and converted from analog to digital by analog-to-digital converter (ADC) 128. For FMCW radar systems, for example, it is known to obtain information on range, speed, and angles by performing multiple Fast Fourier Transforms (FFTs) on samples of radar mixer outputs. A first FFT, also commonly referred to as range FFT, yields range information. A second FFT across the range transformed samples, also commonly referred to as Doppler FFT, yields speed information. The first and second FFTs yield a so-called 2D range-Doppler map comprising range and speed (FFT) bins. An optional third FFT involving phase information of signals of different antenna elements of an (virtual) antenna array can yield additional spatial or angular information-so-called Direction-of-Arrival (DoA) information. The FFT processing may be performed at digital processing block 130.

The FMCW radar apparatus 100 additionally comprises a control circuit 102 which is configured to set different operational modes of the transceiver circuit 110. Control circuit 102 may control transceiver circuit 110 in accordance with different operational modes. The different operational modes may include a (target) detection mode of transceiver circuit 110 and one or more transceiver calibration/monitoring modes of transceiver circuit 110. The detection mode may be used for normal radar operation to obtain information on range, speed, and angles of targets. The one or more transceiver calibration/monitoring modes may be used for calibrating the transmitter and/or the receiver portion of transceiver 110.

In the detection mode, transceiver circuit 110 may be controlled to emit one or more sequences (frames) of subsequent FMCW radar chirps in a transmit frequency band between a minimum transmit frequency and a maximum transmit frequency. For example, transceiver circuit 110 may be controlled (by control circuit 102) to emit a first sequence of subsequent FMCW radar chirps in a first time interval and to emit at least a second sequence of subsequent FMCW radar chirps in at least a subsequent second time interval. Thus, the detection mode of transceiver circuit 110 may refer to normal radar operation for range-Doppler processing. In another operational mode different from the detection mode, transceiver circuit 110 may be controlled to perform one or more other operations of the transceiver circuit 110, e.g., calibration/monitoring.

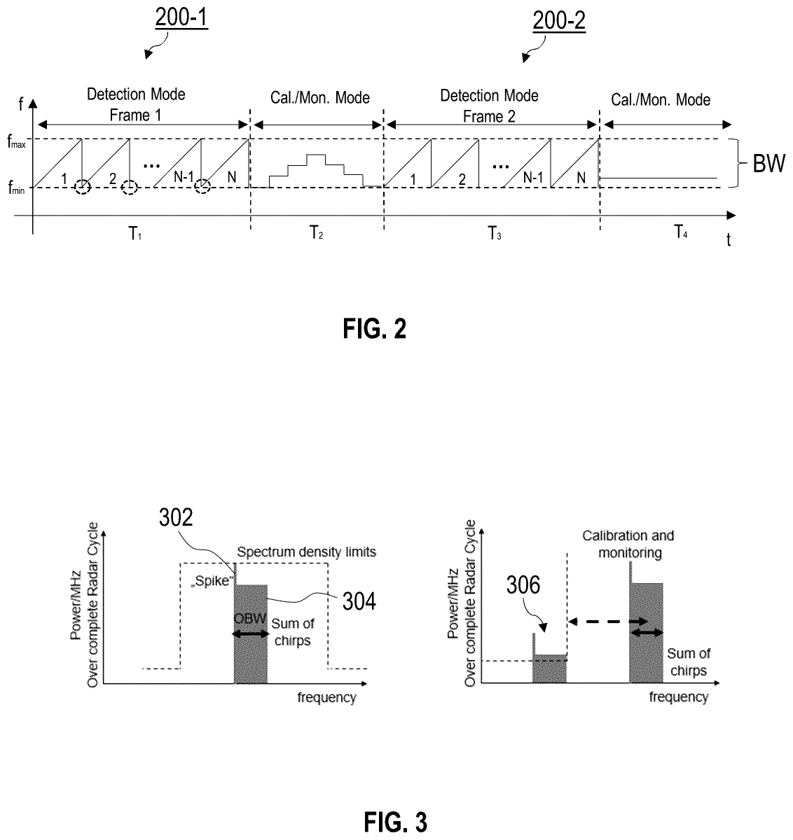

FIG. 2 illustrates an example of subsequent detection and calibration modes of the transceiver 110.

In a first detection mode time interval T₁, transceiver circuit 110 may be controlled to emit a first sequence 200-1 of N subsequent FMCW radar chirps in a transmit frequency band BW between a minimum frequency fₘᵢₙ and a maximum frequency fₘₐₓ, e.g., BW=fₘₐₓ−fₘᵢₙ. That is, in the first detection mode time interval T₁, the frequency synthesizer 112 is controlled to generate the chirps in the transmit frequency band BW between the minimum frequency fₘᵢₙ and the maximum frequency fₘₐₓ. In the illustrated example, the frequency of each of the N radar chirps linearly increases from the minimum frequency fₘᵢₙ to the maximum frequency fₘₐₓ. In a subsequent second calibration/monitoring time interval T₂, transceiver circuit 110 may be conventionally controlled to calibrate the transmitter and/or the receiver portion by adjusting the frequency synthesizer 112 to one or more frequencies inside the transmit frequency band BW during the calibration or monitoring mode. In a subsequent third detection mode time interval T₃, transceiver circuit 110 may be controlled to again emit a second sequence 200-2 of N subsequent FMCW radar chirps in the transmit frequency band BW between the minimum frequency fₘᵢₙ and the maximum frequency fₘₐₓ. In a subsequent fourth calibration/monitoring time interval T₄, transceiver circuit 110 may be controlled to again calibrate the transmitter and/or the receiver portion by adjusting the frequency synthesizer 112 to one or more frequencies inside the transmit frequency band BW during the calibration or monitoring mode.

It is to be noted that FIG. 2 merely illustrates one of many possible examples of FMCW radar chirp sequences and calibration/monitoring frequencies. For example, also FMCW radar chirp sequences with frequency offsets between subsequent FMCW radar chirps are possible, meaning that start and stop frequencies of subsequent chirps could be different, respectively. In such an example, the minimum frequency fₘᵢₙ would denote the minimum start frequency of all chirps, while the maximum frequency fₘₐₓ would denote the maximum stop frequency of all chirps. For example, the minimum start frequency fₘᵢₙ could be the start frequency of the 1^{st} chirp and the maximum stop frequency could be the end or stop frequency of the N-th chirp. Further, also other than linearly frequency modulated FMCW radar chirps are conceivable.

The FMCW radar transceiver 110 needs to be calibrated periodically to ensure accurate and reliable radar measurements or detections. Transceiver calibration is the process of adjusting components of transceiver 110 to compensate for any inaccuracies or errors that may arise during operation. For example, calibration of FMCW radar transceiver 110 may involve adjusting the transmit power of PA 114, receiver sensitivity of LNA 120, and other parameters to ensure that the radar transceiver 110 is operating within desired specifications. Another aspect of transceiver calibration may be ensuring that the transmitted signal is accurately modulated with a linear frequency sweep. Any non-linearities in the frequency sweep can lead to errors in range and velocity measurements. To achieve a linear frequency sweep, the frequency synthesizer 112 used in the radar transceiver 110 has to be precisely calibrated. Calibration of the FMCW radar transceiver 110 may be performed periodically to ensure that the transceiver 110 is operating within the desired (spectral) specifications. As shown in FIG. 2, calibration conventionally uses calibration signals having one or more frequencies inside the transmit frequency band BW during the calibration or monitoring mode. As described below, this may have negative impact on the spectral occupation or radar systems.

International regulations of spectral occupation or radar systems are based on limits for emission of spectral densities for radar signals (wanted emissions), calibration signals (auxiliary signals) and spurious (unwanted emissions). The chirp-based sequences 200 of FMCW signals with a frequency ramp as the wanted signal, and mostly constant frequencies during settling between successive chirps and during transceiver calibrations results in a non-uniform usage of the frequency spectrum. Settling between successive chirps refers to the settling time of the frequency synthesizer's PLL. The settling time denotes the amount of time it takes for the PLL's output signal to stabilize after a change in the input signal. After a frequency chirp has reached its stop frequency (e.g., fₘₐₓ), the control circuit 102 may conventionally set a target frequency of the frequency synthesizer's PLL to the start frequency (e.g., fₘᵢₙ) of the next frequency chirp. The settling time then denotes the amount of time it takes for the PLL's output signal to stabilize at the target frequency (e.g., fₘᵢₙ). If the target frequency of the PLL corresponds to fₘᵢₙ, this may lead to spectral spikes at fₘᵢₙ, for example. FIG. 3 (left) shows a typical example of a spectrum of sequences (frames) 200 of subsequent FMCW radar chirps showing a “spike” 302 for a mostly used frequency part (e.g., fₘᵢₙ) of the sequences (frames) 200—which may be viewed as the “auxiliary part of the sequence” and a “box” or flat spectral response 304 for the FMCW ramp part (BW=fₘₐₓ−fₘᵢₙ) of the radar sequence—which may be viewed as the wanted part of the radar sequence. In other words, the limits of spectral density are determined by the auxiliary part 302 of the signal.

In addition to the wanted signal 304 of the radar chirps plus the auxiliary signals 302, the use of highly digital RF architectures like all-digital PLLs may lead to a set of unwanted signals at well-defined frequency offsets to the transmit or operating frequency band OBW. These digital architectures leverage the digital speed and signal processing power of sub-micron technologies and are mostly used to replace highly accurate analog circuitry that would not shrink significantly with technology node. The frequency offsets are thereby determined by the applied digital clock frequencies and the power spectral density is determined by the amount of digital activity. The regulations further limit the spectral power densities of unwanted emissions dependent on their frequency offset from the center frequency of the radar sequence. FIG. 3 (right) shows an example of digital clock related unwanted signals 306 as an image of the radar chirp at the frequency offset of the digital clock frequency. In some cases, the spectral power density of this unwanted signal 306 may limit the output power of the radar chirps.

The present disclosure proposes concepts to widen the spectrum of the radar sequence by using frequencies outside the radar chirp range BW for calibration and monitoring activities. Thereby, the occupied bandwidth (OBW) may be increased, the power densities of the respective signals may be reduced and the frequency range of the spectral mask may be widened, e.g., the limits may be applied at larger frequency offsets from the carrier.

As described previously, a radar sequence may typically include a calibration of the frequency synthesizer 112, the transmitter portion or the receiver portion of a MMIC. In addition, monitoring or functional safety activities may be carried out in between radar chirps or the chirp frames. The mm-Wave frequency applied during these activities can be used as a degree of freedom in order to reduce the contribution to the height of spectral density during these activities or to widen the bandwidth of the radar cycle.

In accordance with implementations of the present disclosure, transceiver circuit 110 may be controlled by control circuit 102 to emit one or more sequences 200 of subsequent FMCW radar chirps in the transmit frequency band BW between the minimum frequency fₘᵢₙ and the maximum frequency fₘₐₓ during the detection mode. In another operational mode different from the detection mode, e.g., a calibration/monitoring mode, transceiver circuit 110 may be controlled by control circuit 102 to perform one or more other operations of the transceiver circuit 110 by adjusting the frequency synthesizer 112 to one or more frequencies outside the transmit frequency band BW (fₘₐₓ−fₘᵢₙ). This, the other operational mode uses different frequencies of the radar signal 113 than the detection mode. The other operational mode may use frequencies f_{cal} of the radar signal 113 which are smaller than fₘᵢₙ or higher than fₘₐₓ.

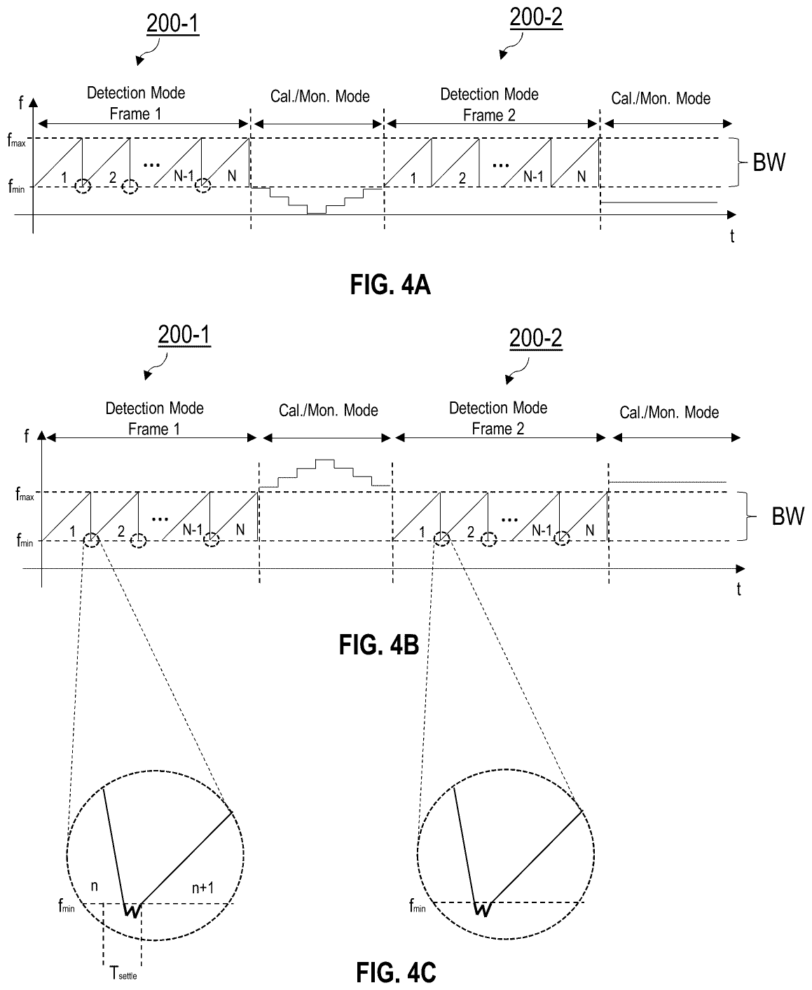

FIG. 4A illustrates an example of subsequent detection and calibration modes of the transceiver 110 in accordance with implementations of the present disclosure.

In the illustrated first detection mode time interval T₁, transceiver circuit 110 may be controlled to emit the first sequence 200-1 of N subsequent FMCW radar chirps in the transmit frequency band BW between the minimum frequency fₘᵢₙ and the maximum frequency fₘₐₓ, e.g., BW=fₘₐₓ−fₘᵢₙ. That is, in the detection mode the frequencies of the radar signal 113 are between the minimum frequency fₘᵢₙ and the maximum frequency fₘₐₓ.

In the subsequent second calibration/monitoring time interval T₂, transceiver circuit 110 may be controlled to calibrate the transmitter and/or the receiver portion by adjusting the frequency synthesizer 112 to one or more frequencies outside the transmit frequency band BW. That is, in the calibration/monitoring mode, the frequencies of the radar signal 113 are smaller than fₘᵢₙ or higher than fₘₐₓ. In the illustrated example of FIG. 4A, transceiver circuit 110 is controlled to calibrate the transmitter and/or the receiver portion by adjusting the frequency synthesizer 112 to one or more frequencies below the transmit frequency band BW during the calibration/monitoring mode. That is, the frequencies of the radar signal 113 are below fₘᵢₙ. In the second calibration/monitoring time interval T₂. the control circuit 102 is configured to vary the frequency of the frequency synthesizer 112 below the transmit frequency band BW. However, during the calibration/monitoring mode, a variation bandwidth of the frequency f_{cal} of the frequency synthesizer 112 may be smaller than the transmit frequency band BW. For example, while the transmit frequency band BW may be 4 GHz, the variation bandwidth of the frequency f_{cal} may be only 1 MHZ, for example.

In the subsequent third detection mode time interval T₃, transceiver circuit 110 may be controlled to again emit a second sequence of N subsequent FMCW radar chirps in the transmit frequency band BW between the minimum frequency fₘᵢₙ and the maximum frequency fₘₐₓ. That is, in the detection mode the frequencies of the radar signal 113 are again between the minimum frequency fₘᵢₙ and the maximum frequency fₘₐₓ.

In the subsequent fourth calibration/monitoring time interval T₄, transceiver circuit 110 may be controlled again to calibrate the transmitter and/or the receiver portion by adjusting the frequency synthesizer 112 to one or more frequencies below the transmit frequency band BW during the calibration or monitoring mode. In the fourth calibration/monitoring time interval T₄, the control circuit 102 is configured to set a constant frequency of the frequency synthesizer 112 below the transmit frequency band BW. That is, the frequency of the radar signal 113 is below fₘᵢₙ.

The control circuit 102 may be configured to adjust, in the calibration/monitoring modes, the frequency synthesizer 102 to frequencies which are equal to or smaller than 99.99% of the minimum frequency fₘᵢₙ. For example, if the minimum frequency of the transmit frequency band BW is 24 GHZ, the control circuit 102 may be configured to adjust, in the in the calibration/monitoring modes, the frequency synthesizer 112 to frequencies which are at most 2.4 MHz below 24 GHZ.

FIG. 4B illustrates a further example of subsequent detection and calibration modes of the transceiver 110 in accordance with implementations of the present disclosure.

In the first detection mode time interval T₁, transceiver circuit 110 is controlled to emit the first sequence 200-1 of N subsequent FMCW radar chirps in the transmit frequency band BW between the minimum frequency fₘᵢₙ and the maximum frequency fₘₐₓ.

In the subsequent second calibration/monitoring time interval T₂, transceiver circuit 110 is controlled to calibrate the transmitter and/or the receiver portion by adjusting the frequency synthesizer 112 to one or more frequencies above the transmit frequency band BW during the calibration/monitoring mode. That is, in the calibration/monitoring mode, the frequencies of the radar signal 113 are higher than fₘₐₓ. In the second calibration/monitoring time interval T₂. the control circuit 102 is configured to vary the frequency of the frequency synthesizer 112 above the transmit frequency band BW. However, during the calibration/monitoring mode, a variation bandwidth of the frequency of the frequency synthesizer 112 may be smaller than the transmit frequency band BW.

In the subsequent third detection mode time interval T₃, transceiver circuit 110 is controlled to again emit a second sequence 200-2 of N subsequent FMCW radar chirps in the transmit frequency band BW.

In the subsequent fourth calibration/monitoring time interval T₄, transceiver circuit 110 is controlled to again calibrate the transmitter and/or the receiver portion by adjusting the frequency synthesizer 112 to one or more frequencies above the transmit frequency band BW. In the fourth calibration/monitoring time interval T₄, the control circuit 102 is configured to set a constant frequency of the frequency synthesizer 112 above the transmit frequency band BW. That is, the frequency of the radar signal 113 is above fₘₐₓ.

The control circuit 102 may be configured to adjust, in the calibration/monitoring modes, the frequency synthesizer 102 to frequencies which are equal to or larger than 100.01% of the maximum frequency fₘₐₓ. For example, if the maximum frequency fₘₐₓ of the transmit frequency band is 86 GHZ, the control circuit 102 may be configured to adjust, in the calibration/monitoring modes, the frequency synthesizer 102 to frequencies which are at least 8.6 MHz above 86 GHZ.

The calibration/monitoring modes during time intervals T₂ and T₄ may comprise transmitter and/or a receiver calibration modes of the transceiver circuit 112. Examples for transmitter calibrations for FMCW radar are:

Output power calibration: This calibration involves measuring the output power of the radar transmitter and adjusting it to meet the specified power level.

Frequency sweep calibration: This calibration involves measuring the frequency sweep of the transmitted signal and adjusting it to ensure that it is linear and covers the required frequency range. Non-linear frequency sweep can cause errors in range and velocity measurements.

Phase noise calibration: This calibration involves measuring the phase noise of the radar transmitter and adjusting it to minimize the noise floor. Phase noise can cause errors in range and velocity measurements, especially at low signal-to-noise ratios.

Timing calibration: This calibration involves measuring the timing of the transmitted signal and adjusting it to ensure that it is synchronized with the receiver. Timing errors can cause errors in range and velocity measurements.

Antenna calibration: This calibration involves measuring the radiation pattern of the radar antenna and adjusting it to ensure that it meets the required specifications. Antenna calibration is important because the accuracy of the radar measurements depends on the antenna performance.

Examples for receiver calibrations for FMCW radar are:
Gain calibration: This calibration involves measuring the gain of the receiver and adjusting it to ensure that it meets the specified gain level.
Phase calibration: This calibration involves measuring the phase response of the receiver and adjusting it to ensure that it is linear over the required frequency range. Non-linear phase response can cause errors in range and velocity measurements.
Frequency response calibration: This calibration involves measuring the frequency response of the receiver and adjusting it to ensure that it meets the required specifications.
Timing calibration: This calibration involves measuring the timing of the receiver and adjusting it to ensure that it is synchronized with the transmitter. Timing errors can cause errors in range and velocity measurements.
Noise figure calibration: This calibration involves measuring the noise figure of the receiver and adjusting it to minimize the noise floor. High noise figure can cause errors in range and velocity measurements, especially at low signal-to-noise ratios.

Assuming a power calibration mode during time interval T₂ and a phase calibration mode during time interval T₄, it may be seen that the control circuit 102 may be configured to adjust the frequency synthesizer 112 to one or more first frequencies outside the transmit frequency band BW during the power calibration mode and to adjust the frequency synthesizer 112 to one or more second frequencies outside the transmit frequency band BW during the phase calibration mode. Although the first and the second frequencies are illustrated as spectrally overlapping frequencies in FIG. 4A and 4B, the skilled person having benefit from the present disclosure will appreciate that the first and the second frequencies may as well be non-overlapping. The latter may further widen the spectrum of the radar sequence by using frequencies outside the radar chirp range BW for calibration and monitoring activities.

A typical transmit power calibration may comprise the following acts:
The PA 114 may have registers to adjust the output power;
The synthesizer 112 may be active at the center frequency of the ramp (fix frequency);
The PA 114 may be active with a 1^{st} power setting;
a coupler may apply a fixed portion of the PA signal to a Power-level-detector (PLD);
the Power-level-detector may measure the PA output power;
the PA 114 may be adjusted to a new output power (with a register);
as a result the PA 114 may be programmed to the desired output power (for this chirp sequence);
according to the present disclosure, the frequency of the synthesizer 112 may be varied during the PA power calibration (preferably as small FMCW ramps with bandwidth significantly larger than 1 MHz but outside ramp BW (max-fₘᵢₙ);
small variation (larger 1 MHz) of the mmWave frequency during calibration to distribute the spectral density to more frequencies than 1 MHz as defined for the measurements of the limits;
increase of the OBW to a large enough value to shift the applicable OOB limits outside the occurrence of unwanted signals (like clock related mixing products), e.g., by moving the frequency for calibrations close to the frequency band limits.
separate mmWave frequencies of transmit phase calibration vs transmit power calibration. A typical phase calibration may comprise the following acts:
the transmitter may have registers to adjust the phase of each transmitter (PA);
the synthesizer 112 may be active at the center frequency of the ramp (fix frequency);
the PAs 114 may be active with the target power setting;
the phase of the 1^{st} PA set to a defined value (e.g., 0°);
the phase of the 1^{st} PA is measured using the TX monitoring path;
the phase of the 1^{st} PA may be adjusted to derive more measurements or to meet target value;
the calibration scheme is repeated for the 2^{nd}, 3^{rd} and 4^{th} PA;
according to the present disclosure, the frequency of the synthesizer 112 may be varied during the PA phase calibration (preferably as small steps (fix value of each measurement, but varied by >1 MHz from phase value to phase value) or FMCW ramps with small enough bandwidth to ensure the desired phase accuracy), also outside ramp BW (fₘₐₓ−fₘᵢₙ)).

Alternatively or additionally to the implementations described with regards to FIGS. 4A and 4B, the control circuit 102 may be configured to vary a target frequency of the frequency synthesizer 112 outside the transmit frequency band BW during a settling time interval Tₛₑₜₜₗₑ of the PLL between the end of an n-th chirp and the start of a subsequent (n+1)-th chirp. An example of this is illustrated in FIG. 4C.

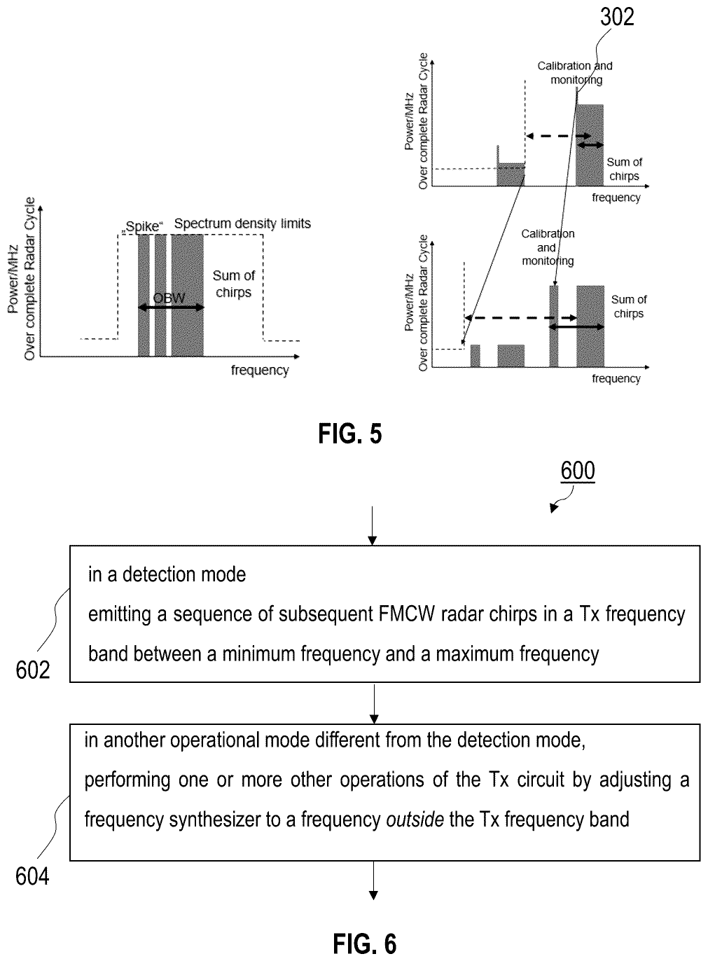

FIG. 4C illustrates a settling time interval Tₛₑₜₜₗₑ of the PLL in which a target frequency of the frequency synthesizer 112 changes from fₘₐₓ to fₘᵢₙ at the end of the n-th chirp. Instead of setting a constant target frequency of the frequency synthesizer 112 inside the transmit frequency band BW (e.g., fₘᵢₙ), the control circuit 102 may be configured to vary the target frequency of the frequency synthesizer 112 below the transmit frequency band BW during the settling time interval Tₛₑₜₜₗₑ of the PLL between the end of the n-th chirp and the start of the directly subsequent (n+1)-th chirp. In this way, the spectral “spike” 302 at fₘᵢₙ may be shifted outside the transmit frequency band BW, as shown in FIG. 5 (left and right). Likewise, the spectral “spike” in the digital clock related unwanted signals 306 may be shifted to lower frequencies, as shown in FIG. 5 (right).

Alternatively to the example shown in FIG. 4C, it is also conceivable that the control circuit 102 is configured to vary the target frequency of the frequency synthesizer 112 above the transmit frequency band BW during the settling time interval Tₛₑₜₜₗₑ of the PLL between the end the n-th chirp and the start of the directly subsequent (n+1)-th chirp. This option could be useful in case of linearly decreasing frequency ramps, for example. In this way, a spectral spike at fₘₐₓ would be shifted above the transmit frequency band BW.

Thus, it is proposed a small variation (larger 1 MHZ) to the mmWave frequency during the wait period between radar cycles (fly-back time, settling time). At the end of each ramp the frequency has a big jump (fₘₐₓ−fₘᵢₙ) to the start of the new ramp (flyback time). Before the new ramp can produce meaningful data, the frequency of the start of the new ramp needs to be within a defined accuracy (wait time). The wait time may be also described as a frequency calibration sequence, in a state-of-the-art system a constant frequency is programmed (e.g., fₘᵢₙ), and the PLL is used to adjust the frequency to the desired accuracy. Here it is proposed that the target frequency value is varied during the frequency calibration in a range significantly larger than 1 MHz and outside transmit frequency band BW. These variations can be considered by the PLL and do not affect the desired accuracy.

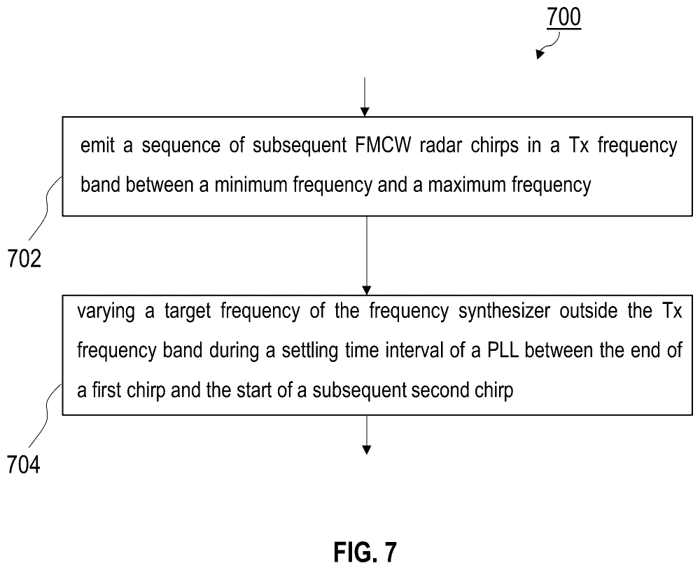

The proposed concept may be summarized by the radar methods shown in FIGS. 6 and 7.

FIG. 6 shows a flowchart of a radar method 600. Radar method 600 includes controlling a transceiver circuit 110 such that the transceiver circuit 110 emits, in a detection mode, a sequence of subsequent FMCW radar chirps in a transmit frequency band BW between a minimum frequency and a maximum frequency (see act 602). In another operational mode different from the detection mode, the transceiver circuit 110 performs one or more other operations by adjusting a frequency synthesizer 112 to a frequency outside the transmit frequency band BW (see act 604).

FIG. 7 shows a flowchart of another radar method 700. Radar method 700 includes controlling a transceiver circuit 110 such that the transceiver circuit 110 emits a sequence of subsequent FMCW radar chirps in a transmit frequency band BW between a minimum frequency and a maximum frequency (see act 702). In act 704, transceiver circuit 110 is controlled to vary a target frequency of the frequency synthesizer 112 outside the transmit frequency band BW during a settling time interval of a PLL between the end of a first chirp and the start of a subsequent second chirp.

By reducing the height of the spectral spikes, the maximum allowed emitted power density during the radar chirps can increased allowing a larger range of operation, cf FIG. 5 (left). This can be achieved by either using antennas with a higher gain or by applying a higher output power from the MMIC to the antenna. By widening the spectral density of the radar sequence, the requirements of OOB (out of band emissions) can be relaxed to higher frequency offsets relative to the center frequency of the radar cycle. As an example, in the ETSI (European Telecommunications Standards Institute) or FCC (Federal Communications Commission) specification this frequency limit for OOB limits is defined by the occupied bandwidth multiplied with a factor of 2.5. As a result, unwanted emission close to the carriers may need to meet the OOB limits which are significantly more relaxed versus the spurs limits. As a result, higher output powers or antenna gain can be applied by avoiding violation of spectral limits in the OOB frequency range, cf FIG. 5 (left).

Both advantages may lead to higher radiated output power while ensuring compliance to regulations: Applying a high output power and thereby enabling a long range for the radar system may have high relevance for users. In case of late occurring compliance issues, changing the OBW can be done by software of the control circuit 102 and does not imply complex changes to the antenna hardware or the radar chirps. In the mid term, with cascaded MMICs and multiple transmitters, the spectral compliance is expected to be more critical and advantages of the proposed concept may become more relevant. In the longer term, technologies beyond 28 nm may be used for radar single chips. This will result in applying more digital architectures and the problem statement will become more relevant.

Implementation examples of the proposed concept may be:
Power calibration of each transmitter at a different mmWave frequencies.
Small variation (larger 1 MHZ) of the mmWave frequency during calibration to distribute the spectral density to more frequencies than 1 MHz as defined for the measurements of the limits.
Small variation (larger 1 MHZ) to the mmWave frequency during the wait period between radar cycles (fly-back time, settling time)
Increase of the OBW to a large enough value to shift the applicable OOB limits outside the occurrence of unwanted signals (like clock related mixing products), e.g., by moving the frequency for calibrations close to the frequency band limits.
Separate mmWave frequencies of transmit phase calibration vs transmit power calibration.
Functional monitoring measurements at mmWave frequencies outside the chirp frequency range.
Separate mmWave frequencies of receiver calibrations (gain, SFDR, coupling losses etc.)
Separate mmWave frequencies of receiver-transmitter loop-back monitoring or calibrations
Separate mmWave frequencies for synthesizer calibrations

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A radar apparatus (100), comprising:
a transceiver circuit comprising a frequency synthesizer; and
a control circuit configured to set different operational modes of the transceiver circuit,
wherein the transceiver circuit is controlled to:
in a detection mode, emit a sequence of subsequent frequency modulated continuous wave (FMCW) radar chirps in a transmit frequency band between a minimum frequency and a maximum frequency; and
in another operational mode different from the detection mode, adjust the frequency synthesizer to a frequency outside the transmit frequency band to perform one or more other operations of the transceiver circuit.

2. The radar apparatus of claim 1, wherein the control circuit is configured to:
adjust the frequency synthesizer to a first frequency inside the transmit frequency band during the detection mode; and
adjust the frequency synthesizer to a second frequency outside the transmit frequency band during the other operational mode.

3. The radar apparatus of claim 1, wherein the control circuit is configured to:
set the detection mode during a transmit time interval; and
set the other operational mode during another time interval outside the transmit time interval.

4. The radar apparatus claim 1, wherein the control circuit is configured to adjust, in the other operational mode, the frequency synthesizer to a frequency which is:
equal to or smaller than 99.99% of the minimum frequency of the transmit frequency band, or
equal to or larger than 100.01% of the maximum frequency of the transmit frequency band.

5. The radar apparatus of claim 1, wherein the control circuit is configured to vary, in the other operational mode, a frequency of the frequency synthesizer outside the transmit frequency band.

6. The radar apparatus of claim 5, wherein the control circuit is configured to vary the frequency of the frequency synthesizer according to a linear frequency ramp or a step function.

7. The radar apparatus of claim 5, wherein a variation bandwidth of the frequency of the frequency synthesizer is smaller than the transmit frequency band.

8. The radar apparatus of claim 1, wherein the other operational mode is a calibration mode or a monitoring mode of the transceiver circuit prior or subsequent to the detection mode, and wherein the control circuit is configured to adjust a frequency synthesizer to the frequency outside the transmit frequency band during the calibration mode or the monitoring mode.

9. The radar apparatus of claim 8, wherein the calibration mode or the monitoring mode comprises a transmitter calibration mode and/or a receiver calibration mode of the transceiver circuit.

10. The radar apparatus of claim 9, wherein the transmitter calibration mode is a power calibration mode or a phase calibration mode of the transceiver circuit.

11. The radar apparatus of claim 10, wherein the control circuit is configured to;
adjust the frequency synthesizer to a first frequency outside the transmit frequency band during the power calibration mode; and
adjust the frequency synthesizer to a second frequency outside the transmit frequency band during the phase calibration mode.

12. The radar apparatus of claim 1, wherein the control circuit is further configured to vary a target frequency of the frequency synthesizer outside the transmit frequency band during a settling time interval of a phase locked loop (PLL) between the end of a first chirp and the start of a subsequent second chirp.

13. The radar apparatus of claim 1, wherein the control circuit is configured to adjust, in the other operational mode, the frequency synthesizer to a frequency in a frequency spectrum between spurious intermodulation products and the transmit frequency band.

14. A radar method, comprising:
controlling a transceiver circuit, wherein controlling the transceiver circuit includes:
emitting, in a detection mode, a sequence of subsequent frequency modulated continuous wave (FMCW) radar chirps in a transmit frequency band between a minimum frequency and a maximum frequency; and
adjusting, in another operational mode different from the detection mode, a frequency synthesizer to a frequency outside the transmit frequency band to perform one or more other operations of the transceiver circuit.

15. A radar apparatus, comprising:
a transceiver circuit comprising a frequency synthesizer; and
a control circuit configured to cause the transceiver circuit to emit a sequence of subsequent FMCW radar chirps in a transmit frequency band between a minimum frequency and a maximum frequency,
wherein the control circuit is configured to vary a target frequency of the frequency synthesizer outside the transmit frequency band during a settling time interval of a phase locked loop, (PLL) between the end of a first chirp and the start of a subsequent second chirp.

16. The radar apparatus of claim 15, wherein the second chirp is directly subsequent to the first chirp.

17. The radar apparatus of claim 15, wherein the control circuit is configured to vary the target frequency within a variation bandwidth, wherein the variation bandwidth is smaller than the transmit frequency band.

18. A radar method, comprising:
controlling a transceiver circuit with a frequency synthesizer, wherein controlling the transceiver circuit with the frequency synthesizer includes:
emitting a sequence of subsequent frequency modulated continuous wave (FMCW) radar chirps in a transmit frequency band between a minimum frequency and a maximum frequency, and
varying a target frequency of the frequency synthesizer outside the transmit frequency band during a settling time interval of a phase locked loop (PLL) between an end of a first chirp and a start of a subsequent second chirp.
